(19) United States
(12) Patent Application Publication
(10) Pub. No.: US 2014/0000363 A1
(43) Pub. Date: Jan. 2, 2014

(54) Method and Apparatus For Measuring Tire Rolling Resistance

(71) Applicant: Hunter Engineering Company, Bridgeton, MO (US)

(72) Inventors: Joel Clasquin, Highland, IL (US); Michael W. Douglas, St. Charles, MO (US); Timothy A. Strege, Sunset Hills, MO (US); Christopher H. Johnson, Valley Park, MO (US); Michael D. Gerdes, O'Fallon, MO (US); Nicholas J. Colarelli, III, Creve Coeur, MO (US)

(21) Appl. No.: 13/927,951

(22) Filed: Jun. 26, 2013

Related U.S. Application Data
(60) Provisional application No. 61/666,268, filed on Jun. 29, 2012.

(51) Int. Cl. G01M 17/02

(52) U.S. Cl. CPC G01M 17/02
USPC 73/462

(57) ABSTRACT

A method by which a vehicle wheel service system, having at least one load roller for applying a generally radial load to a wheel assembly mounted on a driven spindle shaft during rotation thereof, provides a measurement which is representative of the loaded rolling resistance of the wheel assembly undergoing testing. In order to rotationally drive the spindle shaft with the vehicle wheel assembly mounted there on, energy is supplied to a drive motor operatively coupled to rotationally drive the spindle shaft. By monitoring the amount of energy or drive torque required to rotationally drive the spindle shaft and achieve and maintain a desired rotational speed for the wheel assembly when engaged with the load roller, a measurement which is related to the loaded rolling resistance of the wheel assembly is obtained by the vehicle wheel balancing system.

### CROSS-REFERENCE TO RELATED APPLICATIONS

The present application is related to, and claims priority from, U.S. Provisional Patent Application Ser. No. 61/666,268 filed on Jun. 29, 2012, which is herein incorporated by reference.

### STATEMENT REGARDING FEDERALLY SPONSORED RESEARCH

Not Applicable.

### BACKGROUND OF THE INVENTION

The present application is related generally to a method and apparatus for measuring the rolling resistance of a vehicle wheel assembly, consisting of a tire mounted to a wheel rim, when rolling under a loaded condition, and in particular, towards the use of a vehicle wheel service system having a load roller assembly to obtain a measurements associated with a vehicle wheel assembly which are representative of the loaded rolling resistance of the vehicle wheel assembly.

Rolling resistance is fundamentally the parasitic energy a wheel assembly, consisting of a wheel rim and tire mounted thereon, consumes while rolling on a surface under a loaded condition. In other words, it is a measure of the effort required to keep a given tire rolling at a steady speed to compensate for the amount of energy dissipated within the volume of the tire, such as by the viscoelastic behavior of the tire rubber compounds as they cyclically deform during the rotation process. The phenomenon is quite complex, and nearly all operating conditions can affect the final outcome. From measurements based on standardized tests, such as the ISO 28580, SAE J1269, and SAE J2452 tests, it is estimated that 5%-15% of light-duty fuel consumption by passenger vehicles is used to overcome rolling resistance. For heavy trucks, this quantity can be as high as 15%-30%.

Specially designed low-rolling resistance tires have been found to reduce fuel consumption by 1.5%-4.5%. With fuel prices near $4 per gallon, a 5% savings could save a vehicle operator $150 per year or more on fuel. In general, a 10% decrease in rolling resistance for a wheel assembly results in a 1% to 2% decrease in fuel consumption. At lower speeds such as stop-and-go driving, the decrease is 2%, while at highways speeds the decrease is closer to 1% since air resistance is an increased factor at highway speeds.

Information associated with the loaded rolling resistance of a vehicle wheel assembly (i.e., a wheel rim and tire combination) may be useful to a consumer when considering the purchase of new tires for a vehicle, and may be useful for a vehicle service shop when mounting a set of tires to a vehicle. However, traditional methods for measuring the loaded rolling resistance of a vehicle wheel assembly rely upon complex and expensive industrial tire measuring machines. These industrial tire measuring machines are much larger than the typical vehicle service systems found in automotive service shops, and are usually located only in manufacturing facilities or specialized testing facilities. Industrial tire measuring machines often including driven load rollers with diameters significantly greater than the size of the wheel assembly, and/or driven flat moving-belt surfaces designed to simulate the interaction between a vehicle wheel assembly and a flat roadway surface under operating conditions. An example of such a prior art machine, shown in FIG. 1, is the MTS Tire Rolling Resistance Measurement System, manufactured by MTS Systems Corporation of Eden Prairie, Minn. These industrial tire measuring machines utilize multi-axis force sensors to measure various forces exerted on a wheel assembly while pressing the wheel assembly against the large diameter rotationally driven drum mounted in a rigid framework. Multiple wheel mounting spindles permit these industrial tire measuring machines to conduct measurements on multiple wheel assemblies simultaneously, as may be required in a manufacturing environment.

Consumers may be provided with simplified grading information provided by a tire manufacturer regarding the fuel consumption effect of a tire when in a new condition, such as shown on a standardized label (FIG. 2), but have little or no way to determine the rolling resistance effects of used or partially worn tires on a vehicle wheel assembly.

Accordingly, it would be advantageous to provide a method and apparatus by which a measure of the rolling resistance for a vehicle wheel assembly under load may be acquired at any stage of a tire operational lifespan in a vehicle service shop and presented to an operator and/or consumer. It would be further advantageous to provide a measure of the rolling resistance for an individual wheel assembly which can be compared with a corresponding measure for a different wheel assembly, or for the same wheel assembly in a “new” condition, enabling a comparative evaluation there between by a consumer or vehicle service technician.

### BRIEF SUMMARY OF THE INVENTION

Briefly stated, the present invention provides a method by which a vehicle wheel service system, having at least one small-diameter load roller for applying a generally radial load to a wheel assembly mounted on a driven spindle shaft during rotation thereof, can provide a measurement which is representative of the loaded rolling resistance of the wheel assembly undergoing testing. In order to rotationally drive the spindle shaft with the vehicle wheel assembly mounted there on, energy such as in the form of electrical current, is supplied to a drive motor operatively coupled to rotationally drive the spindle shaft. By monitoring the amount of energy or drive torque required to rotationally drive the spindle shaft and achieve and maintain a desired rotational speed for the wheel assembly when engaged with the load roller, a measurement which is related to the loaded rolling resistance of the wheel assembly is obtained by the vehicle wheel service system.

In an embodiment of the present invention, the vehicle wheel service system is configured to measure the duty cycle of a pulse width modulated electrical current supplied to the drive motor for the driven spindle shaft during rotation of a vehicle wheel assembly under an applied load from the load roller. The duty cycle is representative of the energy or drive torque required to rotationally drive the spindle shaft and/or maintain a desired rotational speed, and is related to the loaded rolling resistance of the wheel assembly.

In one embodiment of the present invention, the vehicle wheel service system is configured to store measurements of the duty cycle associated with different vehicle wheel assemblies in order to provide an operator with a relative measure of a difference in loaded rolling resistance there between.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is an illustration of a prior art industrial tire measuring machine;

FIG. 2 is an exemplary prior art standardized tire label providing grading information on new tire fuel economy performance, tire wet weather performance, and tire noise;

FIG. 3 is a table illustrating values for tire pressure, loaded diameter, duty cycle percentage and average duty cycle percentage for six different tires obtained during rolling resistance measurements;

FIG. 4 is a graph illustrating duty cycle measurements for two measurements of each tire of FIG. 3 at 27 PSI inflation pressure;

FIG. 5 is a graph illustrating duty cycle measurements for two measurements of each tire of FIG. 3 at 32 PSI inflation pressure;

FIG. 6 is a graph illustrating duty cycle measurements for two measurements of each tire of FIG. 3 at 37 PSI inflation pressure;

FIG. 7 is a graph illustrating loaded tire diameter measurements of each tire of

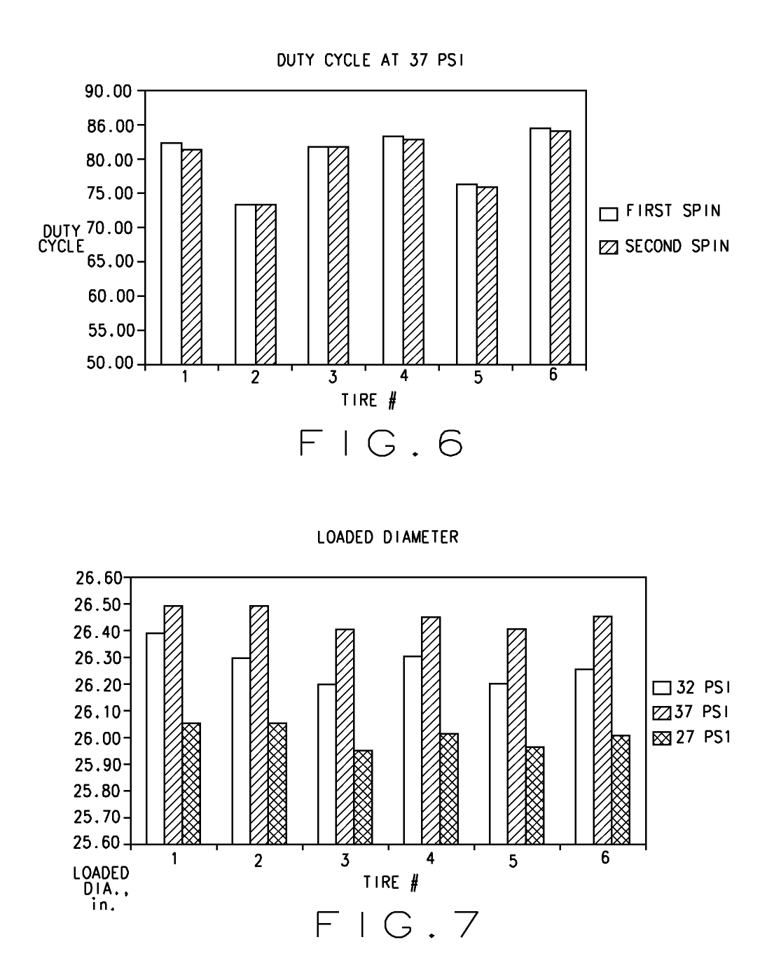

FIG. 1 at the inflation pressures of FIGS. 4-6; and

FIG. 8 is a graph illustrating duty cycle measurements for each tire of FIG. 1 at the inflation pressures of FIGS. 4-6.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

Vehicle wheel service systems for use in automotive service shops and garages which are configured to utilize a small-diameter load roller to apply a generally radial load to a vehicle wheel assembly mounted on a driven spindle shaft are well known in the vehicle service industry. Exemplary vehicle wheel service machines having load rollers with diameters which are less than that of the wheel assembly undergoing service include wheel balancing systems and tire changing systems manufactured by the Hunter Engineering Company of St. Louis, Mo., and can be seen in U.S. Pat. Nos. 6,324,908; 6,336,364; 6,386,031; 6,389,895; 6,393,911; 6,397,675; 6,405,591; 6,422,074; 6,435,027; 6,439,049; 6,609,424; 6,799,460; and 6,854,329, each of which is herein incorporated by reference.

In general, in order to rotationally drive the spindle shaft of the vehicle wheel service system with the vehicle wheel assembly mounted there on, energy such as in the form of electrical current, is supplied to a drive motor operatively coupled to rotationally drive the spindle shaft under control of a suitably programmed processor. By monitoring the amount of energy or drive torque required by the drive motor to rotationally drive the spindle shaft to achieve and maintain a desired rotational speed for the wheel assembly when engaged with the load roller, a measurement which is related to, but not directly representative of, the loaded rolling resistance of the wheel assembly is obtained by the suitably programmed process of the vehicle wheel balancing system. This measurement can be displayed to an operator, processed by the processor to extract useful data, and/or stored in any suitable data storage means for subsequent use. Those of ordinary skill in the art will recognize that the measurement is not a direct representation of the loaded rolling resistance due to a number of other factors which must be overcome when driving a wheel assembly on a spindle, such as friction within the drive assembly and inertia of the driven spindle and drive components.

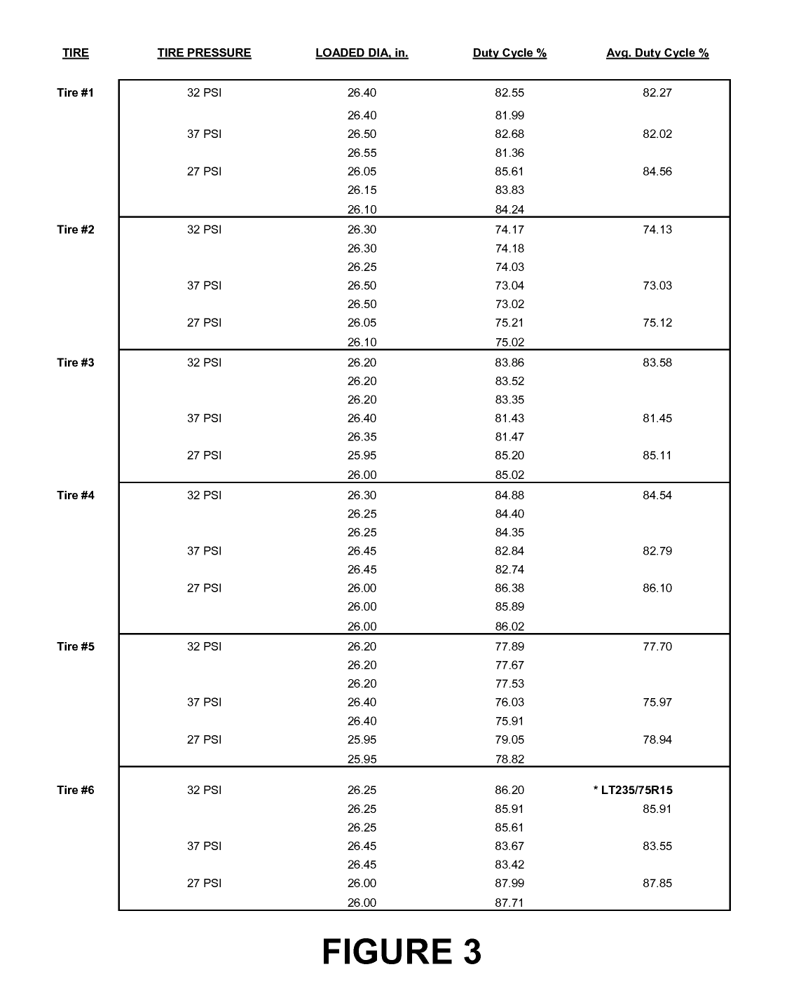

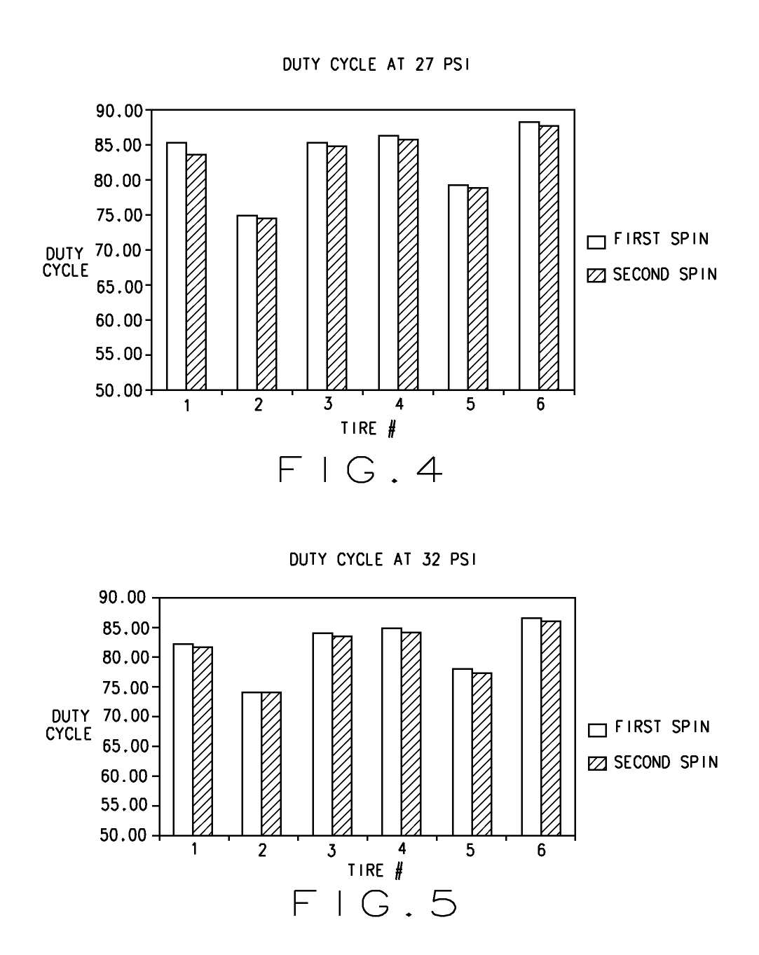

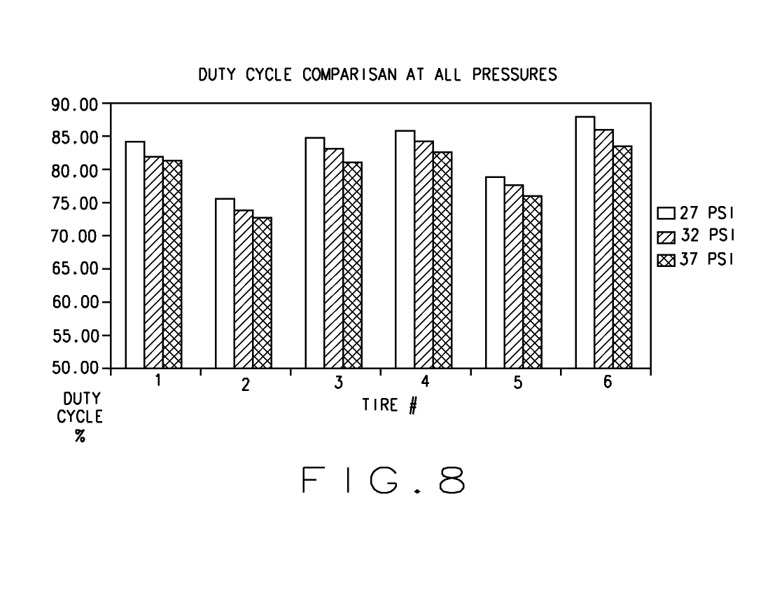

In an embodiment of the present disclosure, a vehicle wheel service system having a suitably controlled electric drive motor configured to drive a spindle shaft to rotate a vehicle wheel assembly mounted there on under an applied load from an engaged load roller. The vehicle wheel service system is further configured with a processing system to control and measure a duty cycle of a pulse width modulated electrical current supplied to the electric drive motor during rotation of the vehicle wheel assembly. The duty cycle of the supplied current is representative of the energy or drive torque required to rotationally drive the spindle shaft, to maintain a desired rotational speed, and/or to transition between first and second rotational speeds, and is related to the loaded rolling resistance of the wheel assembly. As seen in FIGS. 3-8, each measure of the duty cycle percentage for the pulse width modulated current supplied to the wheel service system drive motor is representative of the relative loaded rolling resistance for a corresponding wheel assembly mounted to the vehicle wheel service system and rotationally driven by the drive motor under loaded conditions. Additional factors which can affect the duty cycle percentage may include the pressure to which the tire mounted to the wheel assembly is inflated, and the loaded diameter of the tire, which varies with the inflation pressure.

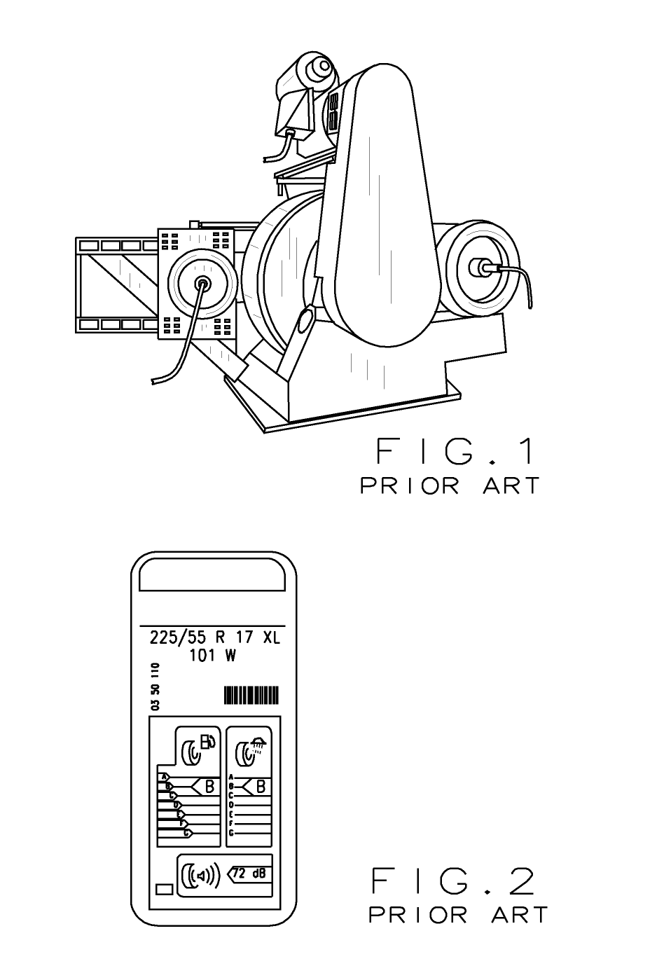

By storing measurements of the duty cycle measurements (or averages) associated with different vehicle wheel assemblies at identified points in time, a vehicle wheel service system may be configured to provide an operator with a visual display or numerical representation of the relative measure of loaded rolling resistance for each evaluated wheel assembly, such as shown at FIG. 8, allowing an operator to quickly identify which wheel assembly (or tire) will provide the lowest loaded rolling resistance from an available collection of wheel assemblies. This information may be further utilized to compare with the information provided by a tire manufacturer for new tires, such as seen on the manufacturer's label shown in FIG. 2, enabling a relative comparison to be made between new and used or partially worn tires when remounting or balancing tires on a vehicle wheel assembly.

In addition to providing an operator with a visual or numerical representative of a relative measure of loaded rolling resistance, the vehicle wheel service system may be configured to store the loaded rolling resistance data in a suitable electronic memory or accessible data store, such as in the form of a database entry. By associating the relative measures of rolling resistance with a time stamp and with specific information identifying the accompanying tire parameters (e.g., brand, model, size, inflation, wear, service age, etc.) which may be obtained automatically using RFID or OCR sensors to retrieve data from the wheel assembly, or entered manually by an operator, the database can be populated to allow for a vehicle service shop to quantify the differences between various tires. These differences may be used to provide valuable information to customers, such as in the form or printed reports or visual presentations such as charts, graphs, or timelines, regarding the relative rolling resistance properties of different tires, different tire conditions, and how such resistances may change as over the service life of the tire. If a means for uniquely identifying tires is employed, the database can be further utilized to track changes in the rolling resistance of a specific tire over time, which may be beneficial to aid in the determination of when a replacement tire is required.

Those of ordinary skill in the art will recognize that a measurement of the energy or drive torque required to rotationally drive the spindle shaft will be effected by a number of factors which may be unique to each individual vehicle wheel service system and to the environment within which it operates. For example, with electrical drives, the average pulse width modulated torque for the same wheel assembly will be different for different vehicle wheel service systems which receive different AC line input voltages from external power sources. A normalized measurement may be obtained if the vehicle wheel service system processing system is suitably configured to receive a measure of the actual electrical voltages or currents within the drive motor.

As an alternative to measuring the energy or drive torque required to rotationally drive the spindle shaft, to maintain a desired rotational speed, and/or to transition between first and second rotational speeds, the vehicle wheel service system may be configured to monitor the time required to transition a rotating vehicle wheel assembly from a first steady-state rotational speed to a second steady-state rotational speed, or to reach a complete stop at zero revolutions per minute (upon removal or reduction of the driving force) while under a loaded condition. In one embodiment, the transition between speeds is controlled by varying the drive current supplied to the drive motor which is rotationally driving the spindle shaft upon which the vehicle wheel assembly is mounted. The resulting measurement of time will be related to the loaded rolling resistance of the wheel assembly in much the same manner as the measurement of energy or drive torque. Alternatively, the resulting measure of time may be viewed as a measure of acceleration time or a measure of deceleration time depending upon the difference between the first and second rotational speeds.

The present disclosure can be embodied in-part in the form of computer-implemented processes and apparatuses for practicing those processes. The present disclosure can also be embodied in-part in the form of computer program code containing instructions embodied in tangible media, or another computer readable storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A vehicle wheel service system having a rotating spindle shaft for receiving a vehicle wheel assembly, a drive motor for rotationally driving the rotating spindle shaft under control of a processing system, and at least one load roller under control of the processing system for applying a generally radial load to the vehicle wheel assembly during rotation, comprising:
wherein the at least one load roller has a diameter which is less than an outer diameter of the vehicle wheel assembly;
wherein the processing system is configured with a set of software instructions to obtain a measure of the energy required to rotationally drive the spindle shaft with the vehicle wheel assembly mounted thereon under an applied load from the load roller; and
wherein the processing system is further configured with a set of software instructions to process said obtained measure of energy to produce a representation of the loaded rolling resistance for the vehicle wheel assembly.

2. The vehicle wheel service system of claim 1 wherein said measure of energy is a duty cycle percentage of a pulse width modulated electrical current supplied to said drive motor; and
wherein said representation of the loaded rolling resistance is expressed as an average duty cycle percentage over two or more spins of said vehicle wheel assembly on said rotating spindle shaft.

3. The vehicle wheel service system of claim 1 wherein said measure of energy is a measure of time required to transition the vehicle wheel assembly from a first steady-state rotational speed to a second steady-state rotation speed.

4. The vehicle wheel service system of claim 3 wherein said transition is implemented by varying the drive current to the motor rotating the said spindle shaft upon which said vehicle wheel assembly is mounted.

5. The vehicle wheel service system of claim 1 wherein said processing system is configured with a set of software instructions to provide a visual display of said loaded rolling resistance representation to an operator.

6. The vehicle wheel service system of claim 5 wherein said visual display is a numerical value.

7. The vehicle wheel service system of claim 5 wherein said visual display is a graphical representation.

8. The vehicle wheel service system of claim 1 wherein said processing system is configured with a set of software instructions to store said loaded rolling resistance representation in an accessible data storage together with at least one associated tire parameter selected from a set of tire parameters including, but not limited to, tire brand, tire model, tire dimensions, tire inflation pressure, tire wear, tire service age, and tire placement location on a vehicle.

9. The vehicle wheel service system of claim 1 wherein said processing system is configured with a set of software instructions to compare said representation of the loaded rolling resistance with one or more representations of loaded rolling resistance stored in an accessible data storage, and to provide an operator with a visual display of the relative differences there between.

10. The vehicle wheel service system of claim 9 wherein said one or more stored representations of loaded rolling resistance are each associated with said vehicle wheel assembly at different tire inflation pressures; and
wherein said visual display of said relative differences provides a representation of changes in loaded rolling resistance for said vehicle wheel assembly.

11. A method for providing a representation of the loaded rolling resistance for a vehicle wheel assembly consisting of a tire mounted to a wheel rim, comprising:
mounting the vehicle wheel assembly to a driven spindle shaft of a vehicle wheel service system;
engaging an outer diameter surface of the vehicle wheel assembly with at least one load roller having a diameter which is less than said outer diameter of the vehicle wheel assembly;
applying a generally radial load to the vehicle wheel assembly via said at least one load roller during driven rotation of the spindle shaft and vehicle wheel assembly;
obtaining a measure of the energy required by a drive motor of the vehicle wheel balancing system to rotationally drive the spindle shaft with the vehicle wheel assembly mounted thereon under said applied load; and
processing said obtained measure of energy to produce a representation of the loaded rolling resistance for the vehicle wheel assembly.

12. The method of claim 11 wherein said measure of energy is a measure of a duty cycle percentage for a pulse width modulated electrical current supplied to said drive motor.

13. The method of claim 11 further including the step of providing a visual display of said loaded rolling resistance representation to an operator.

14. The method of claim 11 further including the step of storing said loaded rolling resistance representation in an accessible data storage, together with at least one associated tire parameter.

15. The method of claim 11 further including the step of comparing said representation of the loaded rolling resistance with one or more stored representations of loaded rolling resistance, and providing an operator with a visual display of the relative differences there between.

16. A method for providing a representation of a loaded rolling resistance for a vehicle wheel assembly consisting of a tire mounted to a wheel rim, comprising:
mounting the vehicle wheel assembly to a driven spindle shaft of a vehicle wheel service system;
applying a generally radial load to the vehicle wheel assembly during driven rotation of the spindle shaft and vehicle wheel assembly;
obtaining a measure of a time required to transition the vehicle wheel assembly from a first steady-state rotational speed to a second steady-state rotational speed; and
processing said obtained measure of time to produce a representation of the loaded rolling resistance for the vehicle wheel assembly.

17. The method of claim 16 further including the step of providing a visual display of said loaded rolling resistance representation to an operator.

18. The method of claim 16 further including the step of storing said loaded rolling resistance representation in an accessible data storage, together with at least one associated tire parameter.

19. The method of claim 16 further including the step of comparing said representation of the loaded rolling resistance with one or more stored representations of loaded rolling resistance; and
providing an operator with a visual display of the relative differences there between.

20. A method for evaluating vehicle tires, comprising:
acquiring, for at least two tires, a measure of loaded rolling resistance for each of said tires, together with data representative of one or more associated tire parameters;
storing said acquired measures of loaded rolling resistance and said associated tire parameters in an accessible data store;
accessing said accessible data store to retrieve at least two acquired measures of loaded rolling resistance and said associated tire parameters;
providing a relative display of said retrieved measures of loaded rolling resistance and said associated tire parameters to enable a comparison there between.
